(19) United States
(12) Patent Application Publication
(10) Pub. No.: US 2023/0141432 A1
(43) Pub. Date: May 11, 2023

(54) CHAIN AND CHAIN LINK WITH SEALING RING

(71) Applicant: HUSQVARNA AB, Huskvarna (SE)

(72) Inventor: Per Carlbäck, Gränna (SE)

(21) Appl. No.: 17/799,497

(22) PCT Filed: Feb. 1, 2021
(86) PCT No.: PCT/SE2021/050071

§ 371 Date: Aug. 12, 2022

(30) Foreign Application Priority Data
Feb. 13, 2020 (SE) 2050154-0

(51) Int. Cl. B27B 33/14; B23D 65/00; B29C 45/14

(52) U.S. Cl. CPC B27B 33/142; B23D 65/00; B29C 45/14344; B29C 2045/14459; B29L 2031/12

(57) ABSTRACT

A method of manufacturing a chain link (8) of an abrasion cutting chain comprises: providing a metal blank with outer contours of the chain link (8) and rivet holes (14); and providing a ring (15) of a seal material by injection-molding of seal material around at least one rivet hole (14). The method further comprises providing a transfer channel (16) in the metal blank adjacent to at least one of the rivet holes (14). The seal material flows via the transfer channel (16) into at least one cavity portion of an injection mold assembly to form at least one rings (15) of seal material. An abrasion chain link comprises at least one rivet hole (14). A transfer channel (16) is provided next to the rivet hole (14).

### FIELD OF THE INVENTION

The present invention relates to a method of manufacturing a chain link of a cutting chain for a power tool, such as a chain saw or a wall saw, the method comprising: providing a metal blank comprising a first lateral side, a second lateral side, outer contours of the chain link and a rivet hole for a rivet connecting to adjacent links, the rivet hole having a rivet hole opening on each of the first and second lateral sides, respectively; and providing a ring of a seal material around at least one rivet hole opening.

The invention also relates to a chain link blank for forming an abrasion cutting chain link, comprising a first lateral side a second lateral side and at least one rivet hole formed as a through-hole with rivet hole openings, on each lateral side of the chain link blank.

The invention further relates to an abrasion cutting chain link, comprising a first lateral side, a second lateral side, and at least one rivet hole, for pivotably coupling the chain link to adjacent chain links, said rivet hole having a rivet hole opening on each of the lateral sides, and at least one sealing ring of a seal material enclosing a respective rivet hole opening.

The invention also relates to an abrasion cutting chain comprising a chain link as above, as well as a power tool comprising such an abrasion cutting chain.

### BACKGROUND

U.S. Pat. No. 6,138,658 discloses an abrasion cutting chain with a number of drive links and cutting links, pivotally connected by rivets. In order to protect the pivotal connections from abrasive particles, sealing O-rings or washers are arranged around the rivets, between the connected, adjacent links.

The sealing effect may be adequate, but the manufacture and assembly of the chain is complex and costly.

### SUMMARY

It is an object of the present invention to solve, or at least mitigate, parts or all of the above mentioned problems. To this end, there is provided a method of manufacturing a chain link as mentioned in the introduction above, wherein the metal blank comprises a transfer channel adjacent to at least one of the rivet hole openings; and in that: providing said ring of seal material comprises injection-molding the ring of seal material onto the metal blank, wherein said injection-molding the ring of seal material onto the metal blank comprises injecting the seal material such that the seal material flows via the transfer channel into at least one cavity portion of an injection mold assembly to form said ring of seal material. Thereby a chain link with a sealing ring around at least one of the rivet holes may be produced in an efficient and cost-effective way. At the same time, a high quality of the sealing ring or rings and their positioning on the chain link may be provided.

In one embodiment the method further comprises injecting the seal material such that the seal material is transferred from the transfer channel into at least two cavity portions of an injection mold to form rings of seal material around at least two rivet hole openings in the link. Hereby an efficient manufacturing method is provided as an option.

In another embodiment the method further comprises injecting the seal material directly into the transfer channel.

Hereby injection gate marks are avoided on the sealing rings, and any gate marks will hence neither cause a reduced sealing effect of the sealing rings, nor will they need to be removed after the injection.

In a further embodiment the method comprises transferring the seal material via the transfer channel to form rings of seal material around at least two rivet hole openings on the same lateral side of the blank. As stated above, seal material injected into the transfer channel may be able to flow from the transfer channel into adjacent cavity portions in the injection mold assembly, to form the sealing rings around the rivet hole openings. Sealing rings on the same side of the blank may be formed simultaneously.

In other embodiments the method further comprises transferring the seal material via the transfer channel to form rings of seal material around at least two rivet hole openings on opposite lateral sides of the blank. Hereby sealing rings on opposite sides of the blank may be formed simultaneously. These sealing rings may be formed at the same time as sealing rings on the same side of the blank are formed. This enables the manufacture of a chain link where all sealing rings are formed on the blank simultaneously.

In further embodiments the method comprises surface treating the metal blank of the chain link before the injection molding.

The metal blank may undergo one or more treatments. The purpose of such treatments may be providing the metal blank itself with selected properties, e.g. regarding corrosion, strength, or appearance. Examples of such treatments are annealing, hardening, galvanizing, etc. Another purpose of such treatments may be providing a functional base for the seal material with respect to adhesion of the seal material onto the metal blank. Examples of such treatments are priming, blasting, or grinding, etc. The material in the metal blank, or in any surface treatment, is selected such as not to affect the seal material adversely, e. g. decreasing its strength, durability, adhesion to the metal blank. By the same token, the seal material is selected so as not to have an adverse impact on the material in the metal blank, e.g. increase the risk of corrosion etc.

In further embodiments the method comprises filling the transfer channel with the seal material.

In still further embodiments the metal blank is cut from sheet metal.

This is an option for providing the metal blank, although other options, known to the skilled person, may be utilized.

According to a second aspect, parts or all of the above mentioned problems are solved, or at least mitigated, by a chain link blank, comprising a first lateral side, a second lateral side and at least one rivet hole formed as a through-hole with rivet hole openings, on each lateral side of the chain link blank, wherein a transfer channel is provided adjacent the rivet hole opening on at least one side of the rivet hole opening. The transfer channel is adapted to be in communication with at least one cavity in an injection mold for forming at least one ring of a seal material around at least one rivet hole opening. A single transfer channel in a suitable place is effective for directing the injection molded seal material to one or more different locations, where the seal material is to be arranged. The production may be less time consuming and less costly if all the sealing rings included in the chain link may be injection molded at the same time in a molding tool, in a single injection shot, which is as uncomplicated as possible. The injection-molding tool need not include more than one injection hole, nor moving parts.

In an embodiment of the chain link blank, the transfer channel is a recess, with a depth which is less than the thickness of the blank.

Hereby one option for the transfer channel is that it is a recess with a limited depth, which serves as a reservoir for seal material, which may flow forward into at least one of the cavity portions of the injection mold assembly, in order to form the sealing ring(s).

In an embodiment there are at least two rivet holes provided in the chain link blank.

In a further embodiment, the transfer channel is arranged between the rivet holes.

Thereby, as stated above, seal material injected into the transfer channel may be able to flow from the transfer channel into adjacent cavity portions in the injection mold assembly, to form the sealing rings around the rivet hole openings. Sealing rings on the same side of the blank may be formed simultaneously.

In still further embodiments, the transfer channel is a through hole in the blank.

With a transfer channel which extends through the blank, one single transfer channel is connectable with cavity portions in the injection mold assembly on both lateral sides of the chain link blank. Seal material injected into the transfer channel may be able to flow from the transfer channel into adjacent cavity portions in the injection mold assembly, to form the sealing rings around the rivet hole openings. Sealing rings on the same side of the blank may be formed simultaneously.

As an alternative, or simultaneously, seal material may flow from the transfer channel into cavity portions on opposite sides of the blank, to form sealing rings on two sides of the blank at the same time. In combination with forming sealing rings on the same lateral side of the blank, all of the sealing rings comprised in the chain link may be formed on the blank at the same time.

In some embodiments the transfer channel has an elongate shape along an extension direction from one of the rivet holes towards the other one. According to an example, the transfer channel may extend approximately half of the distance between the rivet holes.

Hereby the transfer channel may have a favorable position close to the intended position of the sealing rings around the rivet holes. Seal material may easily flow from the channel into the cavity portions in the injection mold assembly.

In some embodiments the transfer channel has dimensions in the range of 1-5 mm, transversally to the extension through the blank, i. e. between the two lateral sides thereof.

In a third aspect of the invention there is provided an abrasion cutting chain link, comprising a first lateral side, a second lateral side, and at least one rivet hole, for pivotably coupling the chain link to adjacent chain links, said rivet hole having a rivet hole opening on each of the lateral sides, and at least one sealing ring of a seal material enclosing a respective rivet hole opening, wherein the sealing ring is arranged on the link by injection-molding. The abrasion cutting chain link comprises a chain link blank as described above, wherein a seal material is arranged in the transfer channel.

The chain link produced by the use of injection molding of the sealing ring or rings is a useful option in the field of abrasion cutting. In this technical field sealing rings are useful for keeping abrasive particles, resulting from the cutting, from the rivets in the joints between the chain links. The joints with the rivets are particularly sensitive to wear from abrasion, since they constantly undergo a rotational movement. Such a rotational movement may, in itself, lead to wear, and abrasive particles tend to enhance such wear, and lead to an untimely breakdown of the cutting chain.

A transfer channel which is filled with seal material after the provision of sealing rings has the effect of providing a sufficient amount of seal material for the sealing rings. Also, a surplus of seal material in the transfer channel provides a seal against abrasive particles entering the inner parts of the sealing rings, thereby risking the breakdown of the sealing rings.

In an embodiment the abrasion cutting chain link has at least one sealing ring, which forms one coherent body with the seal material in the transfer channel.

In further embodiments the at least one sealing ring comprises at least two sealing rings, each arranged around a respective rivet hole opening, and the at least two sealing rings form one coherent body with the seal material in the transfer channel.

By providing one or more rings as a coherent body with the seal material in the transfer channel, the stability and integrity of the abrasion cutting chain link is enhanced.

In still further embodiments, the at least two sealing rings comprise two sealing rings arranged on the same lateral side of the abrasion cutting chain link.

In even further embodiments, the at least two sealing rings comprise two sealing rings arranged on opposite lateral sides of the abrasion cutting chain link.

In a further embodiment the sealing ring has a triangular profile.

Hereby an adequate contact between the sealing ring and an adjacent link may be obtained, for many possible cases of contact forces between the link comprising the sealing ring and the chain link next to it. With low contact forces, only the outer end of the triangular profile may be deformed, which requires only low forces, since the outer end is easily deformed. With higher contact forces, a larger part of the sealing ring may be deformed. In both cases a sufficient sealing to protect the rivets and rivet holes may be obtained.

In further embodiments the sealing ring has a diameter in the range of 3-15 mm.

In still further embodiments, the seal material is chosen from the group including natural rubber, synthetic rubber, and any mixtures thereof.

In even further embodiments, there are two rivet holes provided in the abrasion cutting chain link.

In yet further embodiments, the link is a drive link provided with an inwardly extending drive tooth. The drive tooth may be approximately triangular. The drive link may also be provided with an outwardly extending, approximately triangular bumper projection.

By mounting the drive links at both longitudinal ends of an abrasion cutting link in such a way that a slanting edge of the bumper projection is facing at least in the direction of movement, and optionally also in the opposite direction, the cutting segments, mounted on the cutting links, are protected from damages. In particular, the edges of the segments are protected from excessive impacts, which may chip or crack the segments to such an extent that they may need to be exchanged. At worst the whole cutting chain would have to be exchanged. In consideration of the cost of the segments, an adequate protection thereof is desirable.

In an embodiment the abrasion cutting chain link may be a tie strap.

In an embodiment the abrasion cutting chain link is a cutting link.

In an embodiment the sealing rings are arranged with a symmetry plane oriented parallel with and through an extension plane of the chain link.

In a fourth aspect of the invention, an abrasion cutting chain comprises at least one chain link as described above.

In an embodiment the abrasion cutting chain, with links as described above, includes drive links and cutting links, and sealing rings are arranged on the drive links.

In an embodiment of the chain, the sealing rings are arranged on a first set of links, corresponding circular recesses configured to receive the sealing rings are arranged around rivet holes on a second set of links, and links from the first set and the second set are arranged alternatingly.

Hereby a sealing effect may be obtained by the contact between the sealing ring and the adjacent links without substantially increasing the width of the chain.

In further embodiments the pitch of the chain is in the range of 7-15 mm.

In a fifth aspect of the invention, a power tool comprises an abrasion cutting chain as described above.

It is noted that embodiments of the invention may be embodied by all possible combinations of features recited in the claims. Further, it will be appreciated that the various embodiments described for the method are all combinable with the devices as defined in accordance with the second, third and fourth aspects of the present invention, and vice versa.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a diagrammatic view in perspective of a handheld abrasion cutter;

FIG. 2 is a side view of the abrasion cutting chain comprised in the abrasion cutter in FIG. 1;

FIG. 3a is a perspective view of a drive link comprised in the cutting chain in FIG. 2;

FIG. 3b is a perspective view of a tie strap comprised in the cutting chain in FIG. 2;

FIG. 4 is a schematic cutaway drawing of the drive link in FIG. 3a;

FIG. 5 is a schematic cutaway drawing of drive link according to FIG. 3a connected with a tie strap according to FIG. 3b; and

FIGS. 6a and 6b are sectional views of a sealing ring between the drive link and the tie strap according to FIGS. 3a and 3b in two different cases of clearance.

All the figures are schematic, not necessarily to scale, and generally only show parts which are necessary in order to elucidate the embodiments, wherein other parts may be omitted.

### DETAILED DESCRIPTION OF THE EXEMPLARY EMBODIMENTS

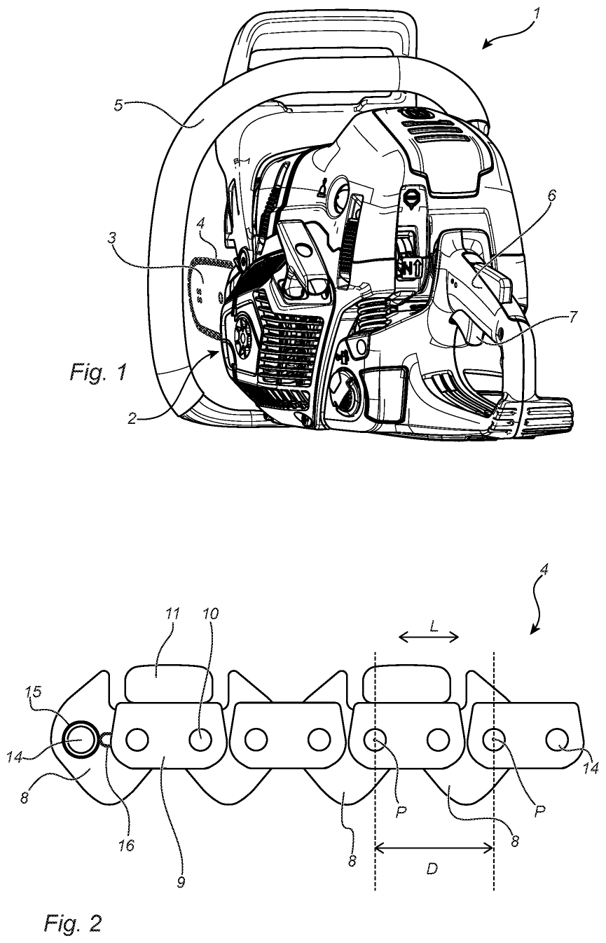

FIG. 1 illustrates a handheld abrasion cutter, i.e. a handheld power cutter 1 configured to cut metal, mineral such as rock or concrete, or the like by abrasive action. The power cutter 1 comprises a power unit 2, which comprises a motor such as an internal combustion engine (not visible) or an electric motor (not visible). In case of an electric motor, the motor is preferably powered by a battery, such as an onboard battery, or by connection to the power grid. A guide bar 3 extends from the power unit 2. An abrasion cutting chain 4 is guided along the guide bar 3. The cutting chain 4 is configured as an endless loop which is moved along the periphery of the guide bar 3 by the motor of the power unit 2. A front handle 5 and a rear handle 6 permit holding the power cutter 1 with two hands, and the rear handle 6 is provided with a trigger 7 for operating the motor (not illustrated).

FIG. 2 illustrates the cutting chain 4, comprising drive links 8 and tie straps 9, which are interconnected by rivets 10. Abrasion cutting teeth 11 are arranged on a number of the tie straps 9, e.g. by welding. The abrasion cutting teeth 11 may include industrial diamonds, in order to attain high abrasion and cutting qualities. The drive links 8 are provided with drive teeth 12 which engage with drive teeth in a drive sprocket in any manner which is known to the skilled person, in order to drive the cutting chain 4 forward. The drive links 8 are provided with bumpers 13, shaped as triangular, outwardly extending projections, which protect the abrasion cutting teeth 11 from excessive impact, especially in the drive direction.

The pitch of the cutting chain 4 is defined as half the distance D between the leading rivet pivot axes P of two consecutive drive links 8; a typical pitch may be, for example, between 8.0 mm and 11.5 mm. Common pitches are ⅜-inch and 0.444-inch pitches.

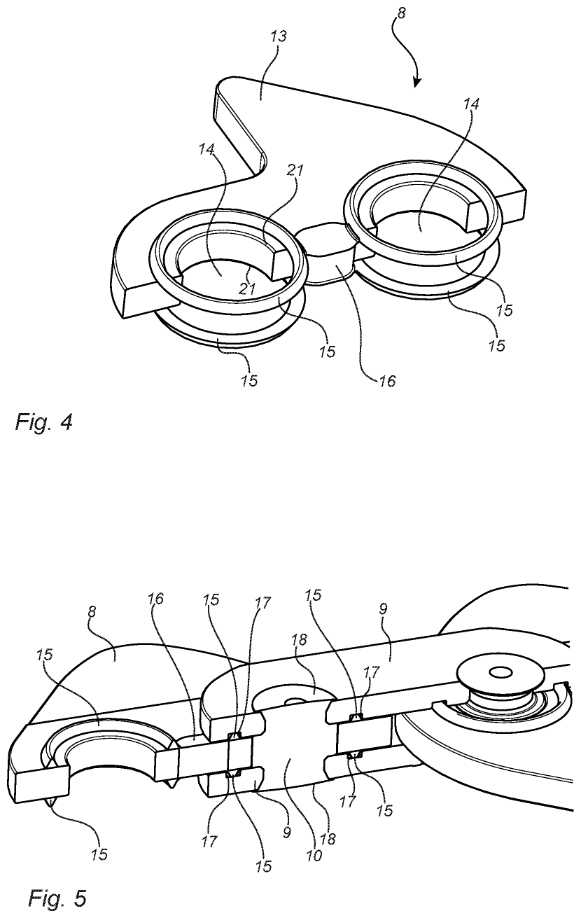

The rivets 10 extend through rivet holes 14 in the drive links 8 and the tie straps 9, respectively. Each rivet hole 14 has an opening 21 (see FIG. 4) on each side of the drive link 8. Around the rivet hole openings 21 in the drive links 8, sealing rings 15, one of which is visible in FIG. 2, are arranged, in order to protect the rivets 10 and links 8, 9 from excessive wear, caused by the rotational motion in combination with abrasive particles, in the area of the rivets 10. The sealing rings 15 will keep abrasive particles from entering the joint of rivets 10 and rivet holes 14.

In order to manufacture the drive links 8 with the sealing rings 15 efficiently, there is provided a transfer channel 16, partly visible in FIG. 2, in the drive link 8. The transfer channel 16 communicates with at least one of the cavities arranged in a tool for injection molding of the sealing rings 15. Seal material will pass through the transfer channel 16 and into at least one of these cavities during manufacture, in order to form the sealing rings 15. In some embodiments the transfer channel 16 communicates with all of the cavities, and thereby all the sealing rings 15 may be formed simultaneously. For the sake of clarity, in the views of FIGS. 2, 3a, 4 and 5 the transfer channel is filled with sealing material, the outer contour of which represents the shape of the transfer channel 16.

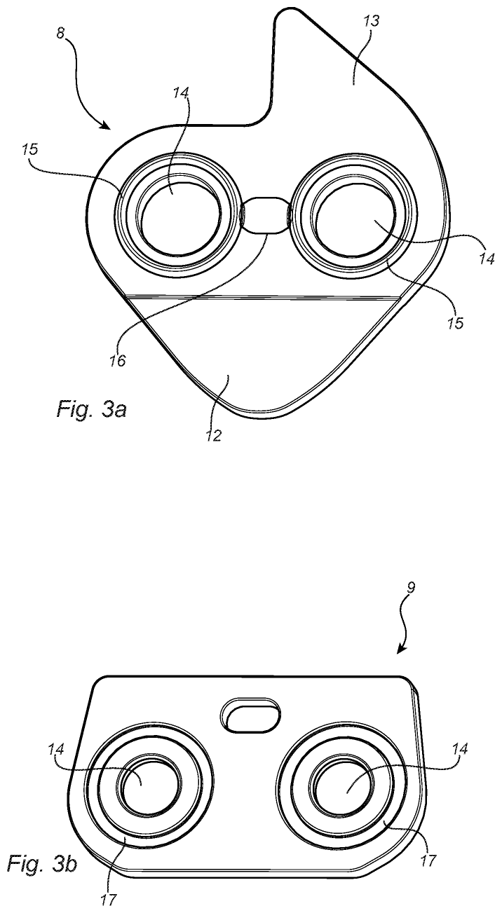

FIG. 3a discloses an isolated drive link 8. The drive tooth 12, for interaction with a drive sprocket (not shown), extends downwards in the figure. The approximately triangular bumper 13 extends upwards in the figure. Two rivet holes 14 are arranged through the drive link 8. The openings 21 of the rivet holes 14 are each surrounded by sealing rings 15. The sealing rings 15 disclosed in the figure are approximately circular and arranged concentrically around the respective rivet hole openings 21, thereby allowing a pivoting motion of the drive link 8 around the respective rivet in the rivet holes 14.

Each sealing ring 15 has, in many embodiments, an approximately triangular profile, which will be more clearly visible in FIGS. 4-6. The transfer channel 16 is arranged approximately aligned with the centers of the rivet holes 14. In this position the transfer channel 16 is in communication with at least one of the cavities in the injection mold for forming at least one of the sealing rings 15. In many embodiments the transfer channel 16 is in communication with at least two of the cavities in the injection mold. If the transfer channel 16 is shallow, i. e. its depth is less than the thickness of the drive link 8, two sealing rings 15 on the same lateral side of the drive link 8 may be formed simultaneously. If the transfer channel 16 is a through hole, i. e. extending between the two lateral sides of the drive link 8, it may communicate with two cavities of the mold on opposite lateral sides of the drive link 8, thereby forming two sealing rings 15 on opposite lateral sides of the drive link 8, around the rivet hole openings 21. In some advantageous embodiments, the transfer channel communicates with all cavities in the tool for injection molding. In these embodiments, all the sealing rings 15 around the rivet hole openings 21, on both lateral sides of the drive link 8, may be formed simultaneously.

The tool for injection molding of the sealing rings 15 will require at least one injection gate for injection of the seal material into the molding tool. Such an injection gate may be placed anywhere in the cavities forming the sealing rings 15, as the seal material will flow from the injection gate into all cavities that communicate with the cavity where the injection gate is arranged, via the transfer channel 16, where applicable. However, placing the injection gate in the transfer channel 16 is advantageous, since the transfer channel 16 is arranged in a central position with short distances to the cavities forming the sealing rings 15. The seal material will in this case flow easily and quickly to all parts of the cavities in the molding tool. Also, there is no risk of gate marks on the sealing rings 15, and hence no removal thereof will be necessary.

The tie strap 9 is disclosed in isolation in FIG. 3b. However, the abrasion cutting tooth 11, as seen in FIG. 2, has not yet been arranged by welding thereon. Similar to the drive link 8, the tie strap 9 has two rivet holes 14 for interconnection with adjacent drive links 8, via rivets 10 in the rivet holes 14.

Around the rivet hole openings there are approximately circular grooves 17 arranged concentrically around the respective rivet hole openings 21, thereby allowing the sealing ring 15 of an adjacent drive link 8 to be received therein, while allowing a pivoting motion of the drive link 8 around the respective rivet 10 in the rivet holes 14. The grooves 17 may be arranged on only one side of the tie strap 9, i. e. on the lateral side of the tie strap 9 intended to face the drive link 8. It is only in the transition area between the drive link 8 and the tie strap 9 that there is a need for a seal. On the outer sides of the tie straps 9 and of the cutting chain 4, the rivet holes 14 are sealed by the rivets 10, which are staved up, i. e. their outer ends are flattened, and will cover the rivet holes 14 from the outside, thereby preventing the entrance of any abrasive particles into the pivoting rivet joints.

The depth of the groove 17 is slightly less than the height of the profile of the sealing ring 15, so that the sealing ring 15 will be slightly compressed when the chain 4 is assembled, and thereby providing a sufficient seal, in all practical cases of clearance between the drive link 8 and the tie strap 9. The bottom of the groove 17 is planar, so that the compression of the sealing ring 15 will be independent of any minor mutual offset in the radial direction of the sealing ring 15 and the groove 17. Hence a good sealing effect will be attained in all practical cases of use.

FIG. 4 is a partial section of the drive link 8, wherein the transfer channel 16 and four sealing rings 15, arranged on both lateral sides of the drive link 8, are clearly visible, as well as a triangular profile of the sealing rings 15. The transfer channel 16 is, in the disclosed embodiment, a through hole, and communicates with all of the sealing rings 15. The seal material has been able to flow into all cavities of an injection mold in order to form the sealing rings 15. As is apparent from the view of FIG. 4, all sealing rings 15 define, together with the sealing material in the transfer channel 16, a single homogenous, coherent, unitary body of sealing material.

Although an injection gate may have been placed anywhere in the injection molding tool, a placement has been made centrally into the transfer channel 16 in the disclosed embodiment. As mentioned above, the seal material will flow into all of the cavities of the molding tool simultaneously.

As an option, the transfer channel 16 may not be a through hole. Instead two shallow transfer channels 16 may be arranged on either side of the drive link 8, each one communicating with two of the sealing rings 15. Injection of seal material, by two different injection gates, into each of the transfer channels 16, will lead to the formation of the sealing rings 15.

Also in FIG. 4, the triangular profile of the sealing rings 15 is visible.

FIG. 5 is a sectional view of a drive link 8 and two tie straps 9 connected therewith by a rivet 10, with flattened ends 18. The flattened ends 18 of the rivets 10 keep abrasive particles from entering the pivoting joint 19 between the rivet 10 and the rivet hole 14. The sealing rings 15 keep the abrasive particles from entering the joint from the side, i. e. between the drive link 8 and the tie straps 9. The sealing rings 15 are arranged in the grooves 17, and the apexes of their triangular profiles are somewhat flattened in contact with the bottom of the grooves 17.

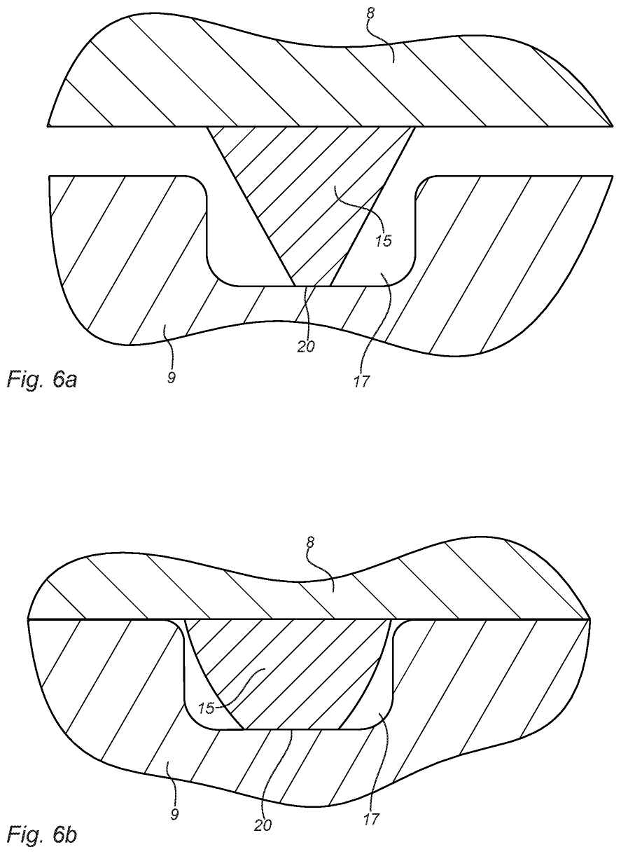

In FIG. 6a, one possible case with maximum clearance between the drive link 8 and the tie strap 9 is shown in enlargement. The sealing ring 15 is arranged in contact with the bottom of the groove 17. The apex 20 of the sealing ring 15 is slightly deformed, in order to provide a seal against abrasive particles. Since the apex 20 is narrow, only a small force is needed to obtain the deformation, i. e. an effective seal is obtainable already when the contact forces between the apex 20 of the sealing ring 15 and the groove 17 are small. Hence there is no urgent need to press the drive links 8 tightly against the tie straps 9 in order to obtain sufficient sealing.

In FIG. 6b, on the other hand, the clearance between the drive link 8 and the tie strap 9 is at a minimum. The contact forces between the sealing ring 15 and the groove 17 are higher, resulting in a larger deformation of the sealing ring 15. This deformation may be received in the groove 17, as seen in FIG. 6b. Hence a pivoting motion between the drive link 8 and the tie strap 9 may still be possible, without impediment from excessive friction forces between the sealing ring 15 and the inner sides of the groove 17.

According to aspects the chain link 8 comprises a first lateral side, a second lateral side, and two rivet holes 14 at distance from one another for pivotably coupling the chain link 8 to adjacent chain links, said rivet holes 14 each having rivet hole openings 21 on both lateral sides of the chain link 8. The chain link 8 further comprises at least two sealing rings 15, each sealing ring 15 enclosing a respective one of at least two rivet hole openings 21, wherein the sealing rings 15 form part of one single coherent body of seal material.

Preferably, the sealing rings 15 are located on different lateral sides of the chain link 8.

Preferably, the chain link 8 comprises four sealing rings 15 each sealing ring enclosing a respective one of four rivet hole openings 21.

According to aspects, a recess is formed in the chain link 8 at a distance from each of the rivet holes 14 in the region between a first plane coinciding with a center axis of one rivet hole and a second plane coinciding with a center axis of the other rivet hole, the first and second planes being perpendicular to a plane coinciding with the center axes of both rivet holes 14. Preferably, said center axes in turn coincide with a respective axis of rotation for the chain link relative to adjacent other chain links to which the chain link 8 is coupled.

According to further aspects, the body is partly accommodated in said recess, and the recess preferably extends all the way through the chain link 8 from one lateral side to the other.

Preferably, the body has a symmetry plane oriented parallel to the lateral sides of the chain link 8 and extending through the chain link 8.

Optionally, the sealing rings 15 are located on one and the same lateral side of the chain link 8.

Preferably, the body is arranged on the chain link 8 by injection-molding.

According to further aspects, the chain link 8 comprises a first lateral side, a second lateral side, and two rivet holes 14 at distance from one another for pivotably coupling the chain link 8 to adjacent chain links, said rivet holes 14 each having rivet hole openings 21 on both lateral sides of the chain link 8. The chain link 8 further comprises at least two sealing rings 15 made of a seal material, each sealing ring 15 enclosing a respective one of at least two rivet hole openings 21. A recess is formed in the chain link 8 and the recess accommodates the same seal material as in the sealing rings 15.

Preferably, the recess extends all the way through the chain link 8 and the seal material accommodated in the recess forms a seal between the both lateral sides of the chain link 8.

The recess is preferably located in the region between a first plane coinciding with a center axis of one rivet hole and a second plane coinciding with a center axis of the other rivet hole, the first and second planes being perpendicular to a plane coinciding with the center axes of both rivet holes 14, wherein said center axes in turn coincide with a respective axis of rotation for the chain link 8 relative to adjacent other chain links to which the chain link 8 is coupled.

The invention has mainly been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality.

1-8. (canceled)

9. A chain link blank for forming an abrasion cutting chain link, comprising a first lateral side a second lateral side and at least one rivet hole formed as a through-hole with rivet hole openings on each lateral side of the chain link blank, wherein a transfer channel is provided adjacent a rivet hole opening, wherein the transfer channel is adapted to be in communication with at least one cavity in an injection mold for forming at least one ring of a seal material around at least one rivet hole opening.

10. The chain link blank according to claim 9, wherein the transfer channel is a recess, with a depth which is less than a thickness of the blank.

11. The chain link blank according to claim 9, wherein the transfer channel is a through hole, penetrating the blank.

12. The chain link blank according to claim 9, wherein there are at least two rivet holes provided in the blank.

13. The chain link blank according to claim 12, wherein the transfer channel is arranged between the at least two rivet holes.

14. The chain link blank according to claim 13, wherein the transfer channel has an elongate shape along an extension direction from one of the at least two rivet holes towards the other one of the at least two rivet holes.

15. The chain link blank according to claim 9, wherein the transfer channel has transversal dimensions in a range of 1-5 mm.

16. An abrasion cutting chain link comprising: a first lateral side, a second lateral side, and a rivet hole for pivotably coupling the chain link to an adjacent chain link, said rivet hole having a rivet hole opening on each of the first and second lateral sides, and a sealing ring of a seal material enclosing the rivet hole opening, wherein the sealing ring is arranged on the abrasion cutting chain link by injection-molding, wherein
the abrasion cutting chain link is formed in a chain link blank having a transfer channel, and wherein a seal material is arranged in the transfer channel.

17. The abrasion cutting chain link according to claim 16, wherein said sealing ring forms one coherent body with the seal material in the transfer channel.

18. The abrasion cutting chain link according to claim 16, wherein said sealing ring is one of at least two sealing rings, each arranged around a respective rivet hole opening, wherein said at least two sealing rings form one coherent body with the seal material in the transfer channel.

19. The abrasion cutting chain link according to claim 18, wherein said at least two sealing rings comprise two sealing rings arranged on a same lateral side of the abrasion cutting chain link.

20. The abrasion cutting chain link according to claim 18, wherein said at least two sealing rings comprise two sealing rings arranged on opposite lateral sides of the abrasion cutting chain link.

21. The abrasion cutting chain link according to claim 16, wherein the sealing ring has a triangular profile.

22. The abrasion cutting chain link according to claim 16, wherein the sealing ring has a diameter in the a range of 3-15 mm.

23. The abrasion cutting chain link according to claim 16, wherein the seal material is chosen from a group including natural rubber, synthetic rubber, and any mixtures thereof.

24. The abrasion cutting chain link according to claim 16, wherein there are two rivet holes.

25. The abrasion cutting chain link according to claim 16, wherein the abrasion cutting chain link a drive link provided with an inwardly extending drive tooth.

26. The abrasion cutting chain link according to claim 16, wherein the abrasion cutting chain link is a tie strap or a cutting link.

27. (canceled)

28. The abrasion cutting chain link according to claim 18, wherein the at least two sealing rings are arranged with a symmetry plane oriented parallel with and through an extension plane of the abrasion cutting chain link.

29-39. (canceled)

40. An abrasion cutting chain comprising the abrasion cutting chain link of claim 16, wherein a pitch of the chain is in a range of 7-15 mm, and wherein sealing rings are arranged on a first set of links, wherein corresponding circular recesses configured to receive the sealing rings are arranged around rivet holes on a second set of links, and wherein the first and second sets of links are arranged alternatingly.

41-44. (canceled)
